(19) United States
(12) Patent Application Publication
(10) Pub. No.: US 2025/0336109 A1
(43) Pub. Date: Oct. 30, 2025

(54) RECORDING MEDIUM, DRAWING APPARATUS, AND DRAWING METHOD

(71) Applicant: Live2D Inc., Tokyo (JP)

(72) Inventor: Tetsuya NAKAJO, Tokyo (JP)

(73) Assignee: Live2D Inc., Tokyo (JP)

(21) Appl. No.: 19/264,660

(22) Filed: Jul. 9, 2025

Related U.S. Application Data
(63) Continuation of application No. PCT/JP2023/000819, filed on Jan. 13, 2023.

(51) Int. Cl. G06T 11/00; G06T 11/20

(52) U.S. Cl. CPC G06T 11/001; G06T 11/203

(57) ABSTRACT

A method obtains, for a reference texture having a reference length and a predetermined width, distribution information regarding a distribution state of elements that form a texture expression in the reference texture, determines a plurality of types of output length that is different from the reference length, determines arrangement positions of the elements in the texture having each types of output length based on the distribution information; and outputs the textures having the plurality of types of output length and the predetermined width by arranging the elements at the determined arrangement positions.

### CROSS-REFERENCE TO RELATED APPLICATION(S)

This application is a continuation of International Patent Application No. PCT/JP2023/000819 filed on Jan. 13, 2023, the entire disclosures of which is incorporated herein by reference.

### BACKGROUND OF THE INVENTION

### Field of the Invention

The present invention relates to a recording medium, a drawing apparatus, and a drawing method, and particularly relates to a drawing technique for line segments accompanied by a texture expression.

### Description of the Related Art

A method for creating electronic illustrations using an information processing apparatus such as a tablet (“digital illustration” or “computer illustration”) is known. With a digital illustration application, various texture expressions can be added to line segments (baselines or outlines) input using a pointing device such as a stylus or a mouse in order to achieve drawing expressions similar to those achieved when drawing illustrations by hand. Such texture expressions include expressions that mimic brush strokes, such as those drawn using writing instruments such as pencils or paintbrushes.

In vector-format digital illustration, the texture expression of a line segment indicating a brush stroke is expressed by disposing texture-forming elements (unit elements for forming a texture, having a unique image pattern matching the texture to be expressed; also known as “sprites”) along a baseline, with the number of texture-forming elements corresponding to the length of the baseline. In other words, a line segment indicating a brush stroke has been expressed by overlapping the texture-forming elements of an image pattern defined for the corresponding brush according to the shape and length of the line segment.

However, in applications where an animation is generated while transforming a two-dimensional image of an illustration that has been created, the texture expression created through a method such as that mentioned above may not produce an appropriate expression. Specifically, with a method which arranges texture-forming elements according to the shape and length of the line segment after transformation, it may not be possible to guarantee the continuity of the arrangement with respect to the texture-forming elements arranged for the line segment before the transformation, resulting in a non-uniform expression. For example, if the baseline changes (is extended) as illustrated in FIGS. 14A to 14D, arranging the texture-forming elements according to the length may cause a change in the placement density or flicker during transitions involved in that change, as illustrated in FIGS. 15A to 15D. As a result, there has been a possibility that an animation created by connecting two-dimensional images from before and after the transformation would interfere with stable viewing.

Japanese Patent No. 6663066 discloses a line segment drawing method that ensures a uniform homogeneous texture expression even when the baseline is changed.

However, in the drawing method described in Japanese Patent No. 6663066, the positions where the texture-forming elements are arranged are determined according to the length of the baseline, the size and transparency of the texture-forming elements are set, and the texture-forming elements are then arranged on the baseline and drawn. The computation amount therefore increases as the baseline becomes longer. In other words, when generating an animation while transforming a two-dimensional image in real time, there has been the possibility that excessive computation amounts would cause processing delays, preventing optimal viewing.

### SUMMARY OF THE INVENTION

Having been conceived in light of the foregoing problem, the present invention provides a recording medium, a drawing apparatus, and a drawing method that generate a texture which forms a desired texture expression that can be seamlessly switched in response to a change in length.

The present invention in its first aspect provides a computer-readable recording medium having recorded thereon a program executed by a computer that outputs textures having a plurality of types of output length, wherein the textures form a texture expression of a line segment having a predetermined width by being disposed in an area corresponding to the line segment when drawing the line segment, and are selectively disposed according to a length of the line segment, the program causing the computer to: obtain, for a reference texture having a reference length and the predetermined width, distribution information regarding a distribution state of texture-forming elements that form a texture expression in the reference texture; determine the plurality of types of output length that indicates a length of a texture to be generated and that is different from the reference length; determine arrangement positions of the texture-forming elements in the texture having each types of output length based on the obtained distribution information; and generate and output the textures having the plurality of types of output length and the predetermined width by arranging the texture-forming elements at the determined arrangement positions.

The present invention in its second aspect provides a drawing apparatus that outputs textures having a plurality of types of output length, wherein the textures form a texture expression of a line segment having a predetermined width by being disposed in an area corresponding to the line segment when drawing the line segment, and are selectively disposed according to a length of the line segment, the drawing apparatus comprising: at least one processor; and at least one memory storing a computer program, the computer program causing the at least one processor to function as the following units: an obtaining unit configured to obtain, for a reference texture having a reference length and the predetermined width, distribution information regarding a distribution state of texture-forming elements that form a texture expression in the reference texture; a first determining unit configured to determine the plurality of types of output length that indicates a length of a texture to be generated and that is different from the reference length; a second determining unit configured to determine arrangement positions of the texture-forming elements in the texture having each types of output length based on the distribution information obtained by the obtaining unit; and a generating unit configured to generate and output the textures having the plurality of types of output length and the predetermined width by arranging the texture-forming elements at the arrangement positions determined by the second determining unit.

The present invention in its third aspect provides a drawing method for outputting textures having a plurality of types of output length, wherein the textures, wherein the textures form a texture expression of a line segment having a predetermined width by being disposed in an area corresponding to the line segment when drawing the line segment, and are selectively disposed according to a length of the line segment, the drawing method comprising: obtaining, for a reference texture having a reference length and the predetermined width, distribution information regarding a distribution state of texture-forming elements that form a texture expression in the reference texture; determining the plurality of types of output length that indicates a length of a texture to be generated and that is different from the reference length; determining arrangement positions of the texture-forming elements in the texture having each types of output length based on the obtained distribution information; and generating and outputting the textures having the plurality of types of output length and the predetermined width by arranging the texture-forming elements at the determined arrangement positions.

Other features and advantages of the present invention will be apparent from the following description taken in conjunction with the accompanying drawings. Note that the same reference numerals denote the same or like components throughout the accompanying drawings.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram illustrating an example of the hardware configuration of a PC 100 according to an embodiment and variations of the present invention;

FIG. 2A is a diagram illustrating the drawing of a line segment accompanied by a texture expression using a texture;

FIG. 2B is a diagram illustrating the drawing of a line segment accompanied by a texture expression using a texture;

FIG. 3 is a diagram illustrating an example of a texture-forming element (a particle);

FIG. 4 is a diagram illustrating a distribution state of particles of a reference texture according to an embodiment and variations of the present invention;

FIG. 5 is a diagram illustrating an example of a reference texture and a concatenated texture according to an embodiment and variations of the present invention;

FIG. 6A is a diagram illustrating a reference texture according to an embodiment and variations of the present invention;

FIG. 6B is a diagram illustrating a concatenated texture according to an embodiment and variations of the present invention;

FIG. 7A is a diagram illustrating the association of particles according to an embodiment and variations of the present invention;

FIG. 7B is another diagram illustrating the association of particles according to an embodiment and variations of the present invention;

FIG. 7C is yet another diagram illustrating the association of particles according to an embodiment and variations of the present invention;

FIG. 7D is a diagram illustrating an example of particles of a first class according to an embodiment and variations of the present invention;

FIG. 7E is a diagram illustrating an example of first particles of a second class according to an embodiment and variations of the present invention;

FIG. 7F is a diagram illustrating an example of second particles of the second class according to an embodiment and variations of the present invention;

FIG. 8 is a diagram illustrating an arrangement frequency of particles in an extended intermediate texture according to an embodiment and variations of the present invention;

FIG. 9A is a diagram illustrating a shortened intermediate texture according to an embodiment and variations of the present invention;

FIG. 9B is a diagram illustrating a shortened intermediate texture according to an embodiment and variations of the present invention;

FIG. 9C is a diagram illustrating an example of a shortened intermediate texture according to an embodiment and variations of the present invention;

FIG. 10 is a diagram illustrating an arrangement frequency of particles in a shortened intermediate texture according to an embodiment and variations of the present invention;

FIG. 11 is another diagram illustrating an example of a shortened intermediate texture according to an embodiment and variations of the present invention;

FIG. 12 is a flowchart illustrating an example of generation processing for generating a line segment drawing texture, executed by the PC 100 according to an embodiment and variations of the present invention;

FIG. 13 is a flowchart illustrating an example of drawing processing for drawing a line segment using a line segment drawing texture, executed by the PC 100 according to an embodiment and variations of the present invention;

FIG. 14A is a diagram illustrating the drawing of a line segment accompanied by a texture expression according to an example of prior art;

FIG. 14B is a diagram illustrating the drawing of a line segment accompanied by a texture expression according to an example of prior art;

FIG. 14C is a diagram illustrating the drawing of a line segment accompanied by a texture expression according to an example of prior art;

FIG. 14D is a diagram illustrating the drawing of a line segment accompanied by a texture expression according to an example of prior art;

FIG. 15A is a diagram illustrating changes in appearance in the drawing of a line segment accompanied by a texture expression according to an example of prior art;

FIG. 15B is a diagram illustrating changes in appearance in the drawing of a line segment accompanied by a texture expression according to an example of prior art;

FIG. 15C is a diagram illustrating changes in appearance in the drawing of a line segment accompanied by a texture expression according to an example of prior art; and

FIG. 15D is a diagram illustrating changes in appearance in the drawing of a line segment accompanied by a texture expression according to an example of prior art.

### DESCRIPTION OF THE EMBODIMENTS

### Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The following embodiment will describe an example in which the present invention is applied in a PC serving as an example of a drawing apparatus capable of generating a texture indicating a texture expression and drawing a line segment accompanied by a texture expression using that texture. However, the present invention can be applied in any device capable of generating a texture indicating a texture expression or drawing a line segment accompanied by a texture expression using the texture.

### Configuration of PC 100

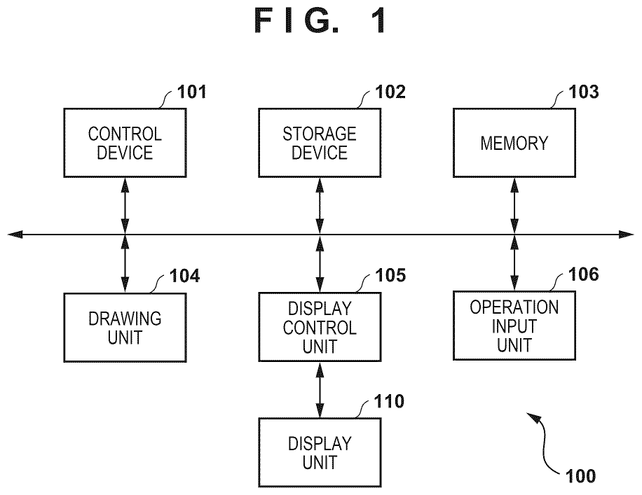

FIG. 1 is a block diagram illustrating the hardware configuration of a PC 100 according to the embodiment of the present invention.

A control unit 101 is a control device, such as a CPU, that controls the operations of the blocks of the PC 100. Specifically, the control unit 101 controls the blocks by reading out a program for an operating system, a program for an illustration editing application including drawing line segments accompanied by texture expressions, and the like stored in a storage device 102, loading the programs into a memory 103, and executing the programs.

The storage device 102 is an information storage device such as, for example, a non-volatile memory such as a rewritable ROM, an HDD that is removably connected to the PC 100, or the like. The storage device 102 may also include a recording medium, such as a disk, having recorded thereon a program having functions provided by the illustration editing application, and which is accessible via a predetermined read-write interface, such as an optical drive or the like. The storage device 102 stores not only the aforementioned programs but also information such as parameters necessary for the blocks to operate, various types of data used for presenting drawing objects, and the like.

The memory 103 is a volatile memory such as a RAM or the like, for example. The memory 103 is used not only as a loading region for loading programs and the like read out from the storage device 102, but also as a storage region for storing intermediate data and the like output during the operations of the blocks. Alternatively, the memory 103 is also used as a region for storing intermediate computation results obtained during the execution of any given processing, computation results, and the like.

A drawing unit 104 is a drawing apparatus such as a GPU, for example. The drawing unit 104 generates a screen (an image) displayed in a display region of a display unit 110. In the present embodiment, the drawing unit 104 generates a screen to be displayed on the display unit 110 by drawing an object including line segments (straight lines and curves) which are expanded over a two-dimensional plane, have variable lengths, and which are accompanied by texture expressions. The screen generated by the drawing unit 104 for the illustration editing application is controlled (that is, the display is updated) by a display control unit 105 for display on the display unit 110.

The display unit 110 may be a display device such as an LCD or the like, for example. Although the display unit 110 is described as a constituent element of the PC 100 in the present embodiment, the present invention is not limited thereto. The display unit 110 need not be configured in the same housing as the PC 100, and may instead be an external display device connected to the PC 100 in a removable state.

An operation input unit 106 is a user interface included in the PC 100, such as a mouse, a keyboard, a pen-based tablet, a game controller, or the like. Upon detecting an operation input made on one or more of these various types of interfaces, the operation input unit 106 outputs a control signal corresponding to that operation input to the control unit 101. Alternatively, the operation input unit 106 notifies the control unit 101 that an event corresponding to that operation input has occurred.

### Drawing Line Segment Accompanied by Texture Expression

The following will describe a method for drawing a line segment accompanied by a texture expression, such as a brush stroke or the like, in the illustration editing application according to the present embodiment.

As described above, in conventional illustration editing applications, a plurality of texture-forming elements have been disposed along a baseline defining the shape of a line segment to form a texture expression. For example, the texture expression of a brush is formed by arranging texture-forming elements corresponding to the brush in a two-dimensional region defined by a line width set for the brush and a baseline, so as to conform to the arrangement frequency of the texture-forming element per unit of length determined according to the thickness of the “paint” of the brush. In other words, the size of the two-dimensional region increases with the length of the baseline, and the texture-forming elements disposed in the region also increase. In the method described in Japanese Patent No. 6663066, where the arrangement position, size, and transparency of each texture-forming element are determined sequentially in order to avoid flickering in the appearance caused by the baseline being transformed, a greater computation amount is required for drawing the line segments as the length of the baseline increases.

However, the PC 100 according to the present embodiment employs a method in which a texture (raster image), in which texture-forming elements are arranged in advance for a predetermined texture expression, is generated for a plurality of types of length patterns, and a line segment is drawn by arranging, on a baseline, a texture having a corresponding length according to a transformation state (and particularly a length in a longitudinal direction) of the baseline. In other words, the texture-forming elements are already arranged in the texture, and thus when drawing the line segment, the arrangement position, size, and transparency of each texture-forming element need not be determined according to the state of the baseline. This makes it possible to reduce the computation amount involved in the line segment drawing processing, compared to the method described in Japanese Patent No. 6663066.

### Texture Generation

The generation of textures having a plurality of types of length patterns and indicating a common texture expression, which are used for drawing a line segment, will be described first. The generation of the texture is assumed to be provided as a function of the illustration editing application in the present embodiment.

In a configuration where a line segment is drawn by applying a texture according to the length of the baseline from among textures generated for a plurality of types of length patterns as described above, it is necessary to generate textures having a plurality of types of length patterns for a single texture expression. In other words, because the length of the baseline is expected to vary greatly, it is necessary to generate textures having a variety of patterns with a suitable length resolution in order to favorably provide a texture expression using the texture.

If a texture having the same length as the baseline is generated, applying the texture to the baseline as-is makes it possible to draw a line segment accompanied by a texture expression indicated by the texture. However, if a texture having the same length as the baseline is not generated, the line segment will be drawn by, for example, extending/shortening the texture which has the closest length and applying that texture to the baseline. At this time, the extension/shortening ratio of the texture is determined according to the difference between the length of the texture and the length of the baseline, but the texture expression of the texture cannot be ensured in the drawn line segment if that ratio deviates significantly from 1.

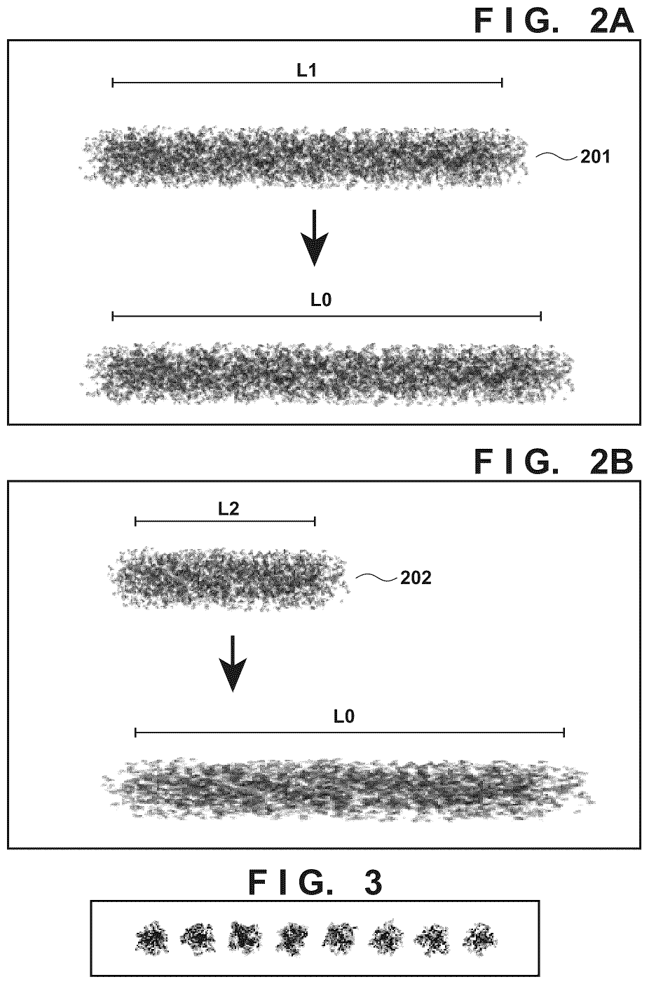

For example, consider a situation where the baseline has a length L0, the closest length is selected from the length patterns in which the textures have been generated, and a texture having that length is extended to L0 and applied to the baseline. As illustrated in FIG. 2A, if the closest length is a length L1 slightly shorter than L0, and a texture 201 having the length L1 is extended and applied to the baseline, a line segment in which the texture expression of the texture 201 is maintained to a certain extent will be drawn. However, as illustrated in FIG. 2B, if the closest length is a length L2 which is much shorter than L0 (about ½, in FIG. 2B), and a texture 202 having the length L2 is extended to L1 and applied to the baseline, a line segment in which the texture expression of the texture 202 is not maintained will be drawn.

In this manner, to draw a line segment having a variable length with a specific texture expression by adding a texture thereto, it is necessary to generate textures having a plurality of types of length patterns at a length resolution which ensures the texture expression will be maintained even if the texture is extended and used.

However, in an illustration editing application, the lengths of line segments are set as desired according to the purpose of the illustration, and preparing textures for an infinite number of lengths is therefore impractical. That said, considering the prerequisite that textures need to be generated at a length resolution sufficient for maintaining the texture expression even if the texture is extended and used, the number of length patterns for generating textures will be enormous.

In particular, in a configuration where the length of a line segment continuously changes, as in animations or the like, it is necessary to select a texture according to the length as appropriate, apply the texture to the line segment, and draw the line segment. In other words, in such a configuration, it is necessary to load textures for each length pattern into the memory in advance. However, if there are a large number of length patterns, the data thereof will occupy a large amount of the memory, which may reduce the computational accuracy and computational efficiency of other processes.

Accordingly, for textures generated for the purpose of drawing a line segment accompanied by a texture expression, it is necessary to generate the textures in a limited length range. In other words, textures generated for drawing line segments generated only for some length patterns. For segments of lengths not included in those length patterns, it is necessary to generate textures that can be expressed by combining the textures of those length patterns.

Furthermore, in a configuration where the length of a line segment continuously changes, as in animations and the like, it is necessary that the texture expression remain uniform among textures for the plurality of types of length patterns, regardless of the length. In other words, in a configuration where the texture to be applied is selected according to the length of the baseline, if the length of the line segment changes continuously, the display transitions by switching to a textures having lengths that differ in stages. As such, a discrepancy between the distribution states of the texture-forming elements (also called simply “particles” hereinafter) between the switched textures may cause flickering in the appearance as described above, due to, for example, a change in the density at which the particles are distributed.

Accordingly, with textures generated for drawing line segments accompanied by texture expressions (also called “line segment drawing textures” hereinafter), when the pattern of textures is switched sequentially in accordance with a step-by-step change in the length of the line segments, it is necessary to ensure continuity in the distribution state of the particles on the line segments between before and after the switch. In other words, even if line segment drawing textures having a plurality of types of length patterns are switched sequentially among textures having different lengths, it is necessary that the arrangement frequency of the particles remain constant, and that an amount of change in the relative arrangement positions of particles indicating the same appearance be kept to a certain level.

To draw a line segment of a desired length by combining limited length patterns as described above, even if a plurality of textures are arranged side by side in the longitudinal direction of the line segment, it is necessary that the distribution state of the particles be uniform and a uniform texture expression be provided. In other words, at boundary regions where textures are arranged adjacent to each other, it is necessary that the particles be distributed in the same manner as in the other regions to ensure a seamless texture expression.

A specific method for generating a line segment drawing texture having a plurality of types of length patterns for a single texture expression will be described next.

### Reference Texture

First, condition information defining rules for generation (particle arrangement conditions) is obtained for the texture expressions indicated by each of the line segment drawing textures.

The texture expression of a pencil or a brush cannot be expressed by uniformly coloring a two-dimensional region where line segments accompanied by that texture expression are drawn with a single color at a fixed density (especially when expressing shades, smudging, and the like). Therefore, as described above, the texture expression is formed by distributing particles having a specific pixel pattern in a somewhat irregular manner. For example, particles are arranged to form a non-uniform, heterogeneous texture expression similar to pencil or brush strokes by irregularly (or according to a specific pattern) changing the density (or hue, brightness, opacity, or the like) on the basis of random numbers or the like. However, if the particles are arranged completely irregularly throughout the entire line segment, the distribution of the particles may become inconsistent, such as the particles becoming sparse in some regions, and the texture expression may therefore not be formed properly throughout the line segment.

In other words, although locally, the particles are arranged irregularly to include heterogeneous expressions, it is also necessary to determine the arrangement conditions such that globally, the particles exhibit a constant distribution state, in order to generate a line segment drawing texture having a common texture expression. In one embodiment, the distribution state of the particles may be defined as the arrangement frequency of the particles per unit of length (number of particles arranged per unit of length≈density). In addition, an average change or dispersion of the hue, brightness, opacity, or the like of the particles can also be used as the distribution state of the particles.

Accordingly, the condition information defines the arrangement frequency of particles per unit of length that should be maintained during generation for the texture expression for which the generation of a line segment drawing texture is required. In the present embodiment, a texture having a prescribed length in the longitudinal direction (called a “reference length” hereinafter) is generated on the basis of the condition information, and line segment drawing textures of other length patterns are generated on the basis of the texture. In other words, one of the generated line segment drawing textures is a texture having the reference length (called a “reference texture” hereinafter), and is generated by determining arrangement positions for the particles according to the condition information and performing the drawing by arranging the particles at the arrangement positions.

Note that the condition information may be generated, for example, by a user setting various parameters related to the particle type, the particle arrangement, and the like for the line segment drawing texture that they wish to generate. When drawing a line segment accompanied by a texture expression, a plurality of types of particles are generally arranged in the drawing region. Each particle is selected in accordance with the texture expression to be formed. For example, in the case of a pencil, eight patterns of particles (raster images), such as those illustrated in FIG. 3, can be used to achieve a somewhat heterogeneous texture expression. More specifically, expanding, reducing, adjusting the opacity, and rotating any of the eight patterns of particles makes it possible to form a texture expression in which the regularity of the particle arrangement is difficult to perceive. Although a single type of particle may be used, doing so makes it easier to perceive the regularity of the arrangement, and it is therefore preferable to employ a plurality of types of particles. Accordingly, in the present embodiment, the condition information is assumed to include information on the type of particles arranged in the texture in addition to information on the arrangement frequency of the particles per unit of length.

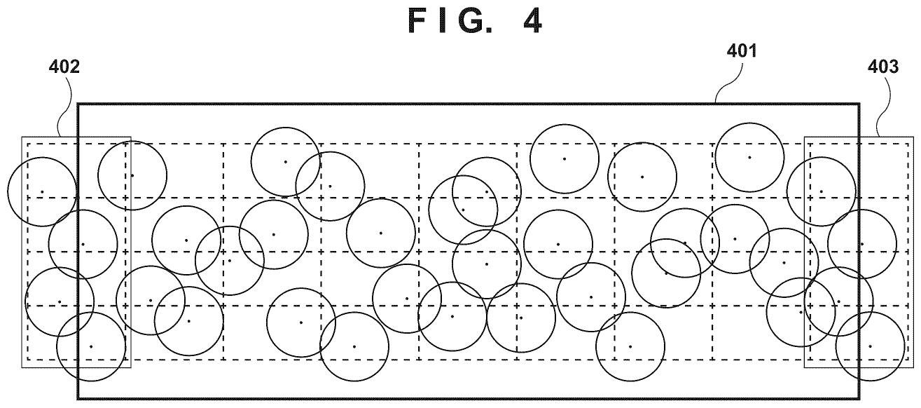

An example of generating the reference texture will be described in detail hereinafter with reference to FIG. 4. In the example illustrated in FIG. 4, the condition information is assumed to define an arrangement frequency in which 32 particles are arranged in a drawing region having the reference length in the longitudinal direction. More specifically, the condition information defines arranging 32 particles in a region 401 having the reference length in the longitudinal direction for a line width at which the texture is to be generated (specifically, a two-dimensional distribution of 8 particles in the longitudinal direction and 4 particles in the width (latitudinal) direction). To facilitate understanding of the invention, the example in FIG. 4 illustrates the one type of particle (circular).

The arrangement positions of the particles during the generation of the reference texture is determined by, for example, dividing the region 401 into a grid on the basis of the condition information and randomly determining center coordinates of the particles arranged in each grid region. In the example in FIG. 4, 36 grid regions (9(=8+1) divisions in the longitudinal direction×4 divisions in the width direction) are defined for the region 401. Depending on the positions of the center coordinates of the particles to be arranged, the images of the particles may be drawn outside the grid regions, and thus the grid regions at the ends in the width direction (the upper end and the lower end) are defined with margins provided.

Here, in the illustration editing application according to the present embodiment, if the length of a line segment is longer than all the line segment drawing textures, the line segment is drawn by arranging a plurality of textures adjacent to each other. Accordingly, when the line segment drawing textures are arranged adjacent to each other, the particles distributed at the ends (boundary parts) thereof are configured so as not to be discontinuous. Accordingly, when a plurality of reference textures are arranged adjacent to each other, it is necessary to employ a configuration in which a common particle pattern appears recursively in units of the reference length.

In other words, among the grid regions defined in the region 401, the particles are arranged in the same arrangement positions in a grid group 402 in the leftmost column and a grid group 403 in the rightmost column. The grid group 402 and the grid group 403 are configured such that only half of each region thereof is included in the region 401, and thus the number of grid regions included in the region 401 is substantially the same as the arrangement frequency per reference length defined in the condition information, namely 32.

In this manner, by defining, in the region 401, the same number of grid regions as the arrangement frequency defined in the condition information, and then arranging the raster images of the particles one by one in each grid region, a constant arrangement frequency is maintained throughout the region 401 as a whole, resulting in a globally homogeneous texture expression being formed. On the other hand, since the arrangement positions of the particles in each lattice are determined at random, the distribution of the particles becomes irregular, and as a result, a texture expression which is locally heterogeneous can be formed.

Information on the arrangement positions of the particles determined for the reference texture is stored as information on the distribution state of the particles in the reference texture (called “reference distribution information” hereinafter). Although the example in FIG. 4 illustrates a single type of particle, it goes without saying that when a plurality of types of particles are included, the distribution information includes information specifying the types of particles arranged at each arrangement position.

### Texture Generation at Length Other Than Reference Length

When the reference texture is generated in this manner, textures for other line segment drawing texture lengths are generated on the basis of the reference texture.

As described above, the reference texture is configured to have a common distribution state for the particles at the ends in the longitudinal direction, and thus a line segment indicating a predetermined texture expression can be drawn longer by arranging the reference texture adjacently. In other words, a line segment having a length that is an integer multiple of the reference length can be drawn while maintaining a globally homogeneous texture expression using only the reference texture. Here, the length of the shortest line segment that can be drawn using only the reference texture is the reference length, and the next length of the line segment that can be drawn using only the reference texture is twice the length of the reference length (called a “double length” hereinafter). Accordingly, the illustration editing application according to the present embodiment generates a line segment drawing texture for each length determined by subdividing a length range up to the double length at a predetermined length resolution.

To rephrase, the reference texture can be drawn while maintaining a proper texture expression for a length that is the reference length or an integer multiple of the reference length, or a line segment having a length that is only slightly different from one of those lengths. However, a line segment having a length that does not correspond to these, i.e., a line segment having a length from 0 to the reference length, or a line segment having a length from the reference length to the double length, cannot be drawn while maintaining a proper texture expression using only the reference texture. The illustration editing application according to the present embodiment therefore generates line segment drawing textures having lengths that differ in stages for a length from 0 to the reference length and a length from the reference length to the double length.

The length pattern at which the line segment drawing texture is generated is defined as a length corresponding to each of stages when the length range up to the double length is divided into 32 stages, 64 stages, or the like (at a length of 0, the line segment drawing texture need not be arranged, and thus 0 stages are excluded). The following will describe an example in which the reference length is taken as 64 pixels, 32 stages are created through equal division up to 128 pixels, which is the double length of the reference length, the length 0 is excluded, and a line segment drawing texture is generated for each stage on the basis of the reference texture.

Although the length resolution is set to 32 stages in the following example for the sake of simplicity, it goes without saying that the length resolution may be set to be finer or rougher in accordance with a setting for how smoothly the switching of the line segment drawing texture is to be presented in response to a change in the length of the line segment, as described above. Furthermore, the divisions need not be equal, and the length at which the line segment drawing texture is to be generated may be sparsely defined for some length ranges and densely defined for others.

The method for generating a line segment drawing texture differs depending on the length of the texture to be generated (called the “output length” hereinafter). As such, both an expression longer than the reference length (an extended expression from the reference length) and shorter than the reference length (a shortened expression from the reference length) will be described below.

### (1) Texture Generation for Extended Expression

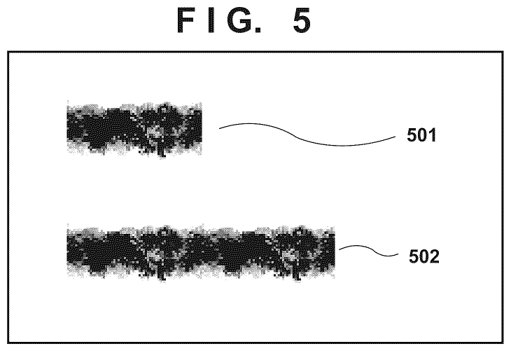

A line segment drawing texture having an output length longer than the reference length, i.e., an output length that is S times the reference length (1<S≤2), is generated with the same particle arrangement state as when two reference textures are adjacent when the length is the double length. In other words, the line segment drawing texture for the extended expression is generated on the basis of a reference texture 501, such as that illustrated in FIG. 5, a double-length texture 502 (called a “concatenated texture” hereinafter) generated by concatenating two of the reference textures 501 in the longitudinal direction, and the distribution state of the particles. More specifically, a texture having an output length that is S times the reference length (1<S≤2) is generated by determining the arrangement positions of the particles in the texture on the basis of the reference distribution information for the reference texture and information indicating the distribution state of the particles for the concatenated texture (called “concatenated distribution information” hereinafter).

Here, the concatenated texture 502 is a line segment drawing texture corresponding to S=2 (the 32nd stage). The present embodiment will describe the concatenated texture 502 as being generated as one of the line segment drawing textures. However, the concatenated texture 502 is a concatenation of two reference textures 501, and will be substituted with the two reference textures 501 also when drawing the line segment as described later. As such, the concatenated texture 502 does not absolutely have to be generated when carrying out the present invention.

The texture for the extended expression is a texture applied when the line segment to which the texture is to be applied is extended sequentially from the reference length to the double length, and it is therefore necessary to maintain the texture expression indicated by the reference texture 501 during the extension process. In addition, when switching the texture to be applied, it is necessary to ensure that the distribution states of the particles are similar such that flicker does not arise in the appearance. In other words, it is necessary to employ a configuration in which the textures for the extended expression exhibit a certain similarity with respect to the local particle arrangement positions while also keeping the arrangement frequency of the particles constant globally. In other words, the texture applied in the process of sequentially extending the line segment from the reference length to the double length is generated by controlling the arrangement positions of the particles in accordance with the output length such that the distribution state of the particles indicated by the reference distribution information gradually approaches the distribution state of the particles indicated by the concatenated distribution information.

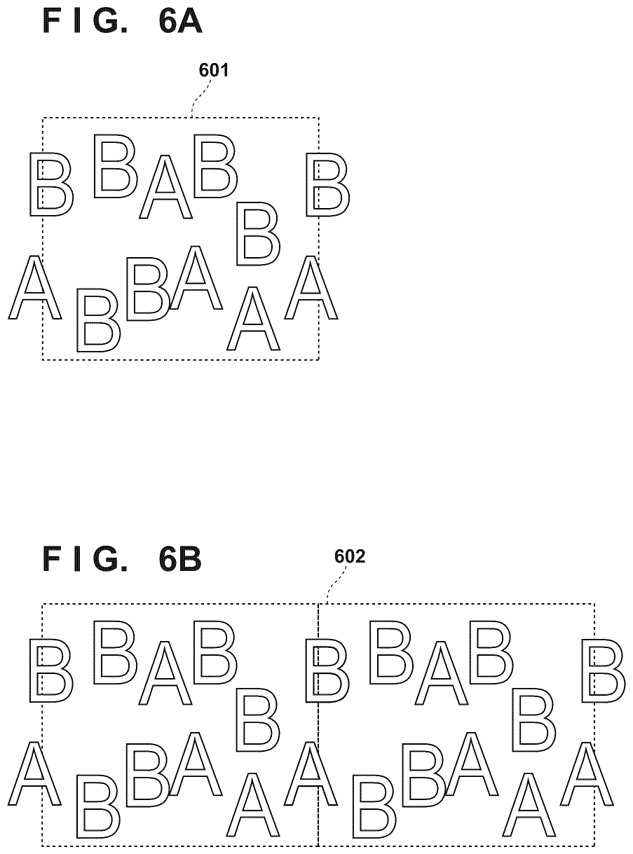

A method for determining the arrangement positions of the particles for generating a line segment drawing texture having an output length of S times the reference length (1<S<2) (called an “extended intermediate texture”) will be described hereinafter with reference to FIGS. 6A and 6B. To facilitate understanding of the invention, in the example illustrated in these drawings, it is assumed that the particles constituting the line segment drawing texture have two patterns, namely A and B, and each particle in the drawings is represented in an identifiable manner by setting the appearance of the particle to the letter “A” or “B”. For example, when the particles in a reference texture 601 are distributed as illustrated in FIG. 6A, a concatenated texture 602 at the double length is generated by concatenating two of the reference texture 601 in the longitudinal direction, and thus the particles are distributed as illustrated in FIG. 6B.

In generating the extended intermediate texture, the particles distributed in the reference texture 601 and the particles distributed in the concatenated texture 602 are associated with each other first. Here, “association” refers to associating particles which have similar relative positions in the texture, and which indicate the same pattern, as the same particles between the reference texture 601 and the concatenated texture 602.

In other words, particles which are successfully associated are particles that stay in constant relative positions, regardless of the change in the length in the longitudinal direction, in an expression in which the reference texture 601 extends and changes to the concatenated texture 602. In other words, the particles which are successfully associated are particles that remain in a region where the relative positions are common, without disappearing in the process of extending the line segment to twice the reference length, and are particles that are arranged in the same relative positions in the extended intermediate texture as well. In other words, the particles which are successfully associated are particles that are always arranged in a region where the relative positions are common, regardless of the length, in an output length that is longer than the reference length.

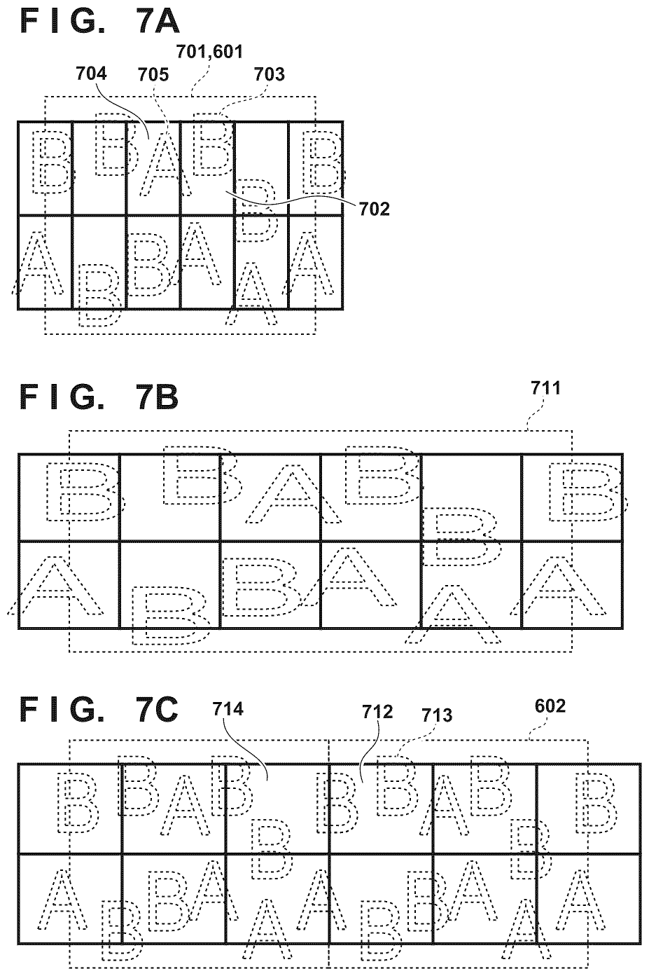

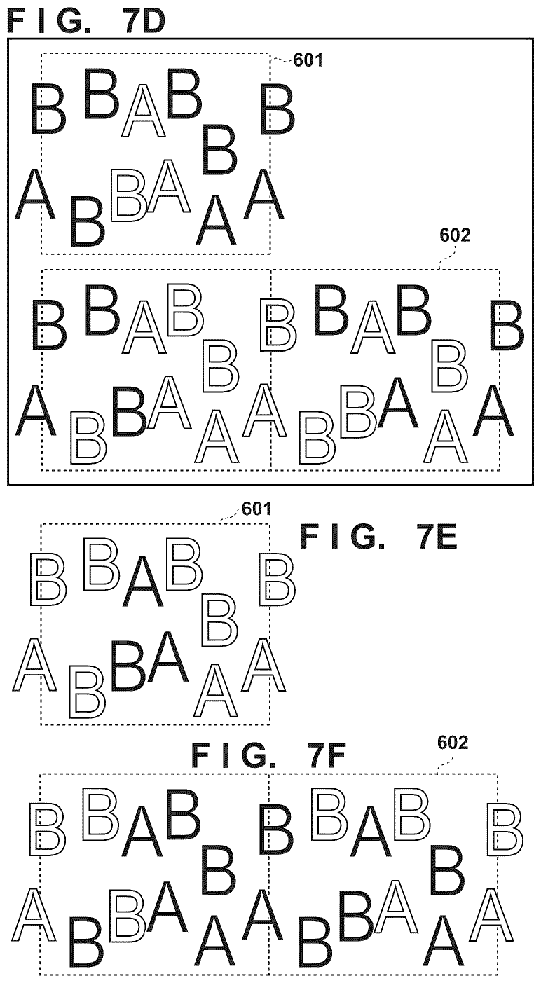

Here, the region where the relative positions are common may be determined on the basis of, for example, a grid defined when the reference texture 601 is generated, as illustrated in FIGS. 7A to 7C. Consider a case where the reference texture 601 is generated by substantially defining 10 grid regions (5 divisions in the longitudinal direction×2 divisions in the width direction) in a region 701 for that texture, and either particles A or B are arranged in each of the grid regions, as illustrated in FIG. 7A. In this case, when the region 701 for the reference texture 601 is extended to double the length in the longitudinal direction, the grid regions are also extended to double the length in the longitudinal direction, as illustrated in FIG. 7B. A region 711 illustrated in FIG. 7B is the same size as the region for the concatenated texture 602, and thus the region indicated by the grid regions extended to double the length in the longitudinal direction is specifies as a region, in the concatenated texture 602, that corresponds to the grid regions in the reference texture 601. FIG. 7C is a diagram in which the grid in FIG. 7B is superimposed on the concatenated texture 602. The grid region of the reference texture 601 and the grid region of the concatenated texture 602, which are specified identified by grid coordinates (M, N) using a row number M and a column number N of the grid, are therefore regions in which the relative positions are common.

A particle 703 of the pattern B is disposed in a grid region 702 specified by grid coordinates (4, 1) in FIG. 7A, and a particle 713 of the pattern B is disposed in a grid region 712 specified by the same grid coordinates in FIG. 7C. Accordingly, the particle 703 and the particle 713 disposed in the grid regions at grid coordinates (4, 1) can be associated between the reference texture 601 and the concatenated texture 602.

On the other hand, a particle 705 of the pattern A is disposed in a grid region 704 specified by grid coordinates (3,1) in FIG. 7A, but a particle of the pattern A is not disposed in a grid region 714 specified by the same grid coordinates in FIG. 7C. Accordingly, the particle 705 disposed in the grid region at grid coordinates (3, 1) cannot be associated between the reference texture 601 and the concatenated texture 602. In other words, the particle 705 is not associated because there are no particles in the concatenated texture 602 which have the same pattern and for which the change in the relative position is small.

As a result of this association, each particle distributed in the reference texture 601 and the concatenated texture 602 is first classified into a first class, which is a class of particles successfully associated, and a second class, which is a class of particles that could not be associated. In other words, the particles in the first class are the particles filled with black out in FIG. 7D, where the arrangement is maintained in a region at constant relative positions regardless of the length of the extended intermediate texture. On the other hand, the particles in the second class are particles which are or are not are arranged in a region at constant relative positions depending on the length of the extended intermediate texture. To be more specific, the particles of the second class include first particles, filled with black in FIG. 7E, which are present in the reference texture 601 but disappear from the region of a common relative position as the length of the extended intermediate texture increases; and second particles, filled with black in FIG. 7F, which are not present in the reference texture 601 but which appear as the length of the extended intermediate texture increases.

Because the concatenated texture 602 is generated by concatenating the reference textures 601, the particles in the grid regions at the ends of the reference texture 601 are always classified into the first class. Accordingly, like the reference texture 601, even if the extended intermediate textures are arranged adjacent to each other on a line segment when drawing the line segment at a length longer than the double length, the particles do not become discontinuous at the boundary part.

The arrangement positions of the particles are determined for the length of each stage in the extended expression on the basis of the results of classifying the particles distributed in the reference texture 601 and the concatenated texture 602, and the extended intermediate texture is generated. In other words, when the distribution state of the particles at the reference length (the reference distribution information) and the distribution state of the particles at the double length (the concatenated distribution information) have been finalized, if the particles are arranged at random in the extended intermediate texture indicating the extension process, the continuity of the distribution states of the particles cannot be ensured and flickering may occur in the appearance. It is therefore assumed that only the particles distributed in the reference texture 601 and the concatenated texture 602 are used to generate the extended intermediate texture, and when determining the arrangement position of each particle, the particles are classified according to their characteristics, and different determination methods are used for each class as described hereinafter, according to the texture length.

For the particles of the first class, there are particles which are associated with both the reference texture 601 and the concatenated texture 602. The arrangement position of such a particle in the extended intermediate texture is therefore determined on the basis of the relative position of the particle in the reference texture 601 and the relative position of the particle in the concatenated texture 602.

As described above, because the particles of the first class are particles that are distributed in the same pattern and in regions where the relative positions between the textures are common, strictly speaking, it is possible that the relative positions of the particles will differ between the reference texture 601 and the concatenated texture 602. For example, assuming the X coordinate (an absolute coordinate) at the left end of each texture is defined as X=0 and the X coordinate (absolute coordinate) of a particle [i] in the reference texture 601 is Xᵢ, the X coordinate (absolute coordinate) of the associated particle [i] in the concatenated texture 602 may not necessarily be 2Xᵢ, but may rather be 2Xᵢ′, which is close to 2Xᵢ. Accordingly, the arrangement position of the particle [i] in the extended intermediate texture is determined while moving the relative X coordinate from Xᵢ to Xᵢ′ as the output length increases. In other words, the arrangement position of the particle [i] is determined so as to move sequentially from the relative coordinate in the reference texture 601 to the position of the relative coordinate in the concatenated texture 602 as the output length increases. Specifically, an X coordinate (absolute coordinate) Xₒᵤₜ of the arrangement position of the particle [i] in the extended intermediate texture at an output length Lₒᵤₜ may be derived as follows:

$${X}_{o u t} = {X}_{i} \times \frac{{L}_{o u t}}{{L}_{ref}} + ( {X}_{i}^{′} - {X}_{i} ) \times \frac{{L}_{o u t} - {L}_{ref}}{{L}_{dub} - {L}_{ref}}$$

Here, L_{ref} represents the reference length, and L_{dub} represents the double length.

Note that the determination of the arrangement positions is determined to be controlled such that the particles of the first class that are disposed at the ends of the extended intermediate texture are disposed at the same relative positions in both the reference texture 601 and the concatenated texture 602. In other words, because the relative positions of the particles of the first class at the ends are controlled to be the same in an extended intermediate texture of any length, processing for moving the relative positions of the particles according to the output length does not occur.

In contrast, the particles of the second class are present in one of the reference texture 601 and the concatenated texture 602, but no corresponding particles are present in the other. It is therefore not necessary to move the arrangement positions to different relative positions in the process of the extended expression, as is the case with particles of the first class. Accordingly, for the first particles of the second class included only in the reference texture 601, the arrangement positions in the extended intermediate texture are determined such that the relative positions of the particles in the reference texture 601 are maintained. In other words, with respect to the particle [i] in the reference textures 601, for which the X coordinate (absolute coordinate) is Xaᵢ, the X coordinate (absolute coordinate) Xaₒᵤₜ of the arrangement position in the extended intermediate texture having an output length Lₒᵤₜ is derived as follows:

$$X {a}_{o u t} = X {a}_{i} \times \frac{{L}_{o u t}}{{L}_{ref}}$$

For the second particles of the second class included only in the concatenated texture 602, the arrangement positions in the extended intermediate texture are determined such that the relative positions of the particles in the concatenated texture 602 are maintained. In other words, with respect to the particle [i] in the concatenated texture 602, for which the X coordinate (absolute coordinate) is Xbᵢ, the X coordinate (absolute coordinate) Xbₒᵤₜ of the arrangement position in the extended intermediate texture having an output length Lₒᵤₜ is derived as follows:

$$X {b}_{o u t} = X {b}_{i} \times \frac{{L}_{o u t}}{{L}_{dub}}$$

For the particles of the second class, the arrangement size is determined such that the extended intermediate texture indicates an expression that disappears or appears according to the output length. In other words, for the first particles, an arrangement size (0) at which the particles are visible at an output length that is close to the reference length is determined, but are not visible at an output length that is close to the double length, is determined. On the other hand, for the second particles, an arrangement size (0) at which the particles are not visible at an output length that is close to the reference length is determined, but are visible at an output length that is close to the double length, is determined. In other words, the arrangement size of the first particles decreases (the particles are not displayed) as the output length increases, and increases (the particles are displayed) as the output length decreases. On the other hand, the arrangement size of the second particles increases (the particles are displayed) as the output length increases, and decreases (the particles are not displayed) as the output length decreases.

Which arrangement size to be used for each particle at which output length may be determined in accordance with the arrangement frequency of the particles, determined for the reference texture 601. In other words, maintaining the arrangement frequency of the particles per unit of length for the reference texture 601 makes it possible to ensure a homogeneous texture expression in the extended intermediate texture.

Here, in the present embodiment, maintaining the arrangement frequency of the particles means that when a grid of the same size as that used when generating the reference texture 601 is defined, the area occupied by the particles disposed in each grid region is adjusted to be equivalent to the area of one particle of the reference texture 601, as illustrated in FIG. 8. In other words, depending on the output length, the arrangement positions of a plurality of particles may be included in a single grid region, and in this case, the arrangement size of each particle is adjusted to no greater than 1 (a default size) to bring the sum of the sizes of all the particles to 1. In other words, in an embodiment where an arrangement frequency is such that a single particle is arranged per grid region, that arrangement frequency will not be maintained if the arrangement positions of the particles determined with respect to the output length are included in the same grid region. Accordingly, the arrangement frequency is maintained through adjustment such that the particle sizes also include 0.

FIG. 8 illustrates an example in which substantially 14 grid regions having the same size as those defined when generating the reference texture illustrated in FIGS. 7A to 7F (specifically, a two-dimensional distribution of 7 in the longitudinal direction and 2 in the width direction) can be defined in a region 801 having the output length in the longitudinal direction. A grid region 802 includes two particles 803 and 804, and the arrangement sizes of the two particles are therefore determined according to the classes thereof. For example, if one of the particles is a particle of the first class, the arrangement size of that particle is kept at 1 regardless of the output length in the extended expression, and thus the arrangement size of the other particle is determined to be 0. Furthermore, if, for example, any of the particles are particles of the second class, the arrangement size of the first particle is determined according to a size equal to the output length minus the reference length, and the arrangement size of the second particle is determined according to a size equal to the double length minus the output length.

Although FIG. 8 illustrates an output length at which an integer number of grid regions of the same size as that defined when generating the reference texture can be defined in the longitudinal direction, it goes without saying that the present invention is not limited thereto. Depending on the output length, it may not be possible to define an integer number of grid regions in the longitudinal direction, and it therefore may not be possible to set the arrangement frequency of the particles to the same as that in the reference texture. In this case, the arrangement frequency of the particles for the extended intermediate texture may be controlled such that a difference from the arrangement frequency of the particles for the reference texture is less than a predetermined threshold. Here, the threshold is assumed to be set to a level at which the difference in appearance between the extended intermediate texture and the reference texture is not visible.

Additionally, although the present embodiment describes a method in which the arrangement size of the particles is adjusted to maintain the arrangement frequency of the particles in the generation of the extended intermediate texture, the present invention is not limited thereto. For example, the arrangement frequency of the particles in the extended intermediate texture may be maintained by adjusting the opacity of the particles. Alternatively, the arrangement frequency may be maintained by adjusting both the arrangement size and the opacity of the particles.

### (2) Texture Generation for Shortened Expression

Meanwhile, a line segment drawing texture having an output length shorter than the reference length, i.e., an output length that is S times the reference length (0<S<1) (called a “shortened intermediate texture” hereinafter), has no texture to be used as a specific reference for the arrangement positions of the particles, as with the concatenated texture. As such, when determining the arrangement positions of the particles of the shortened intermediate texture for a shortened expression, a texture obtained by shortening the reference texture is shortened such that the longitudinal direction length thereof matches the output length (called simply a “shortened texture” hereinafter) is generated, and the distribution state of the particles in the shortened texture is referenced. In other words, in the illustration editing application, the arrangement positions of the particles in the shortened intermediate texture at the output length are determined on the basis of the reference distribution information for the reference texture and shortened distribution information indicating the distribution state of the particles in the shortened texture generated for that output length.

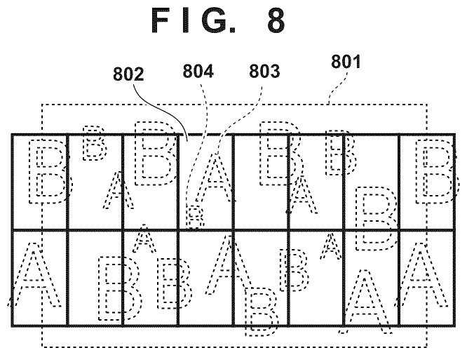

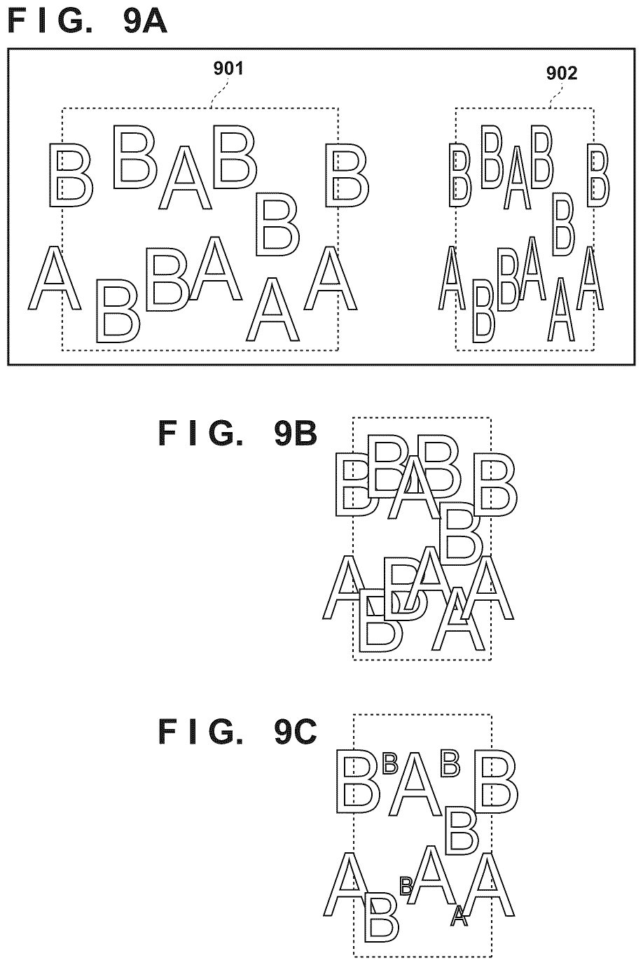

FIG. 9A illustrates an example of a reference texture 901 and a shortened texture 902 in which the reference texture 901 is shortened to ½ the size in the longitudinal direction. As illustrated here, in the shortened texture 902, the particles have an overall shape which is compressed in the longitudinal direction, and thus a texture expression similar to that of the reference texture 901 is not provided. However, if the shapes of the particles are kept the same as in the reference texture 901, the density at which the particles are arranged may become higher than in the reference texture 901, as illustrated in FIG. 9B. In other words, if all the particles in the shortened texture 902 are set to the same size as the particles in the reference texture 901, the arrangement frequency of the particles will change. It therefore becomes necessary to adjust the arrangement size of the particles in the same manner as the extended expression in order to generate the shortened intermediate texture.

The arrangement size may be adjusted in the same manner as for the particles of the second class in the extended intermediate texture. For example, as illustrated in FIG. 10, when a grid of the same size as that used when generating the reference texture 901 is defined in the region for the shortened texture 902, the sum of the sizes of all particles disposed in the region can be set to 1 in each grid region.

Here, when a plurality of particles are arranged in the grid region, a priority level may be set, for example, according to the distance from the center of the corresponding grid region (i.e., the priority increases with proximity to the center). The arrangement size of the particles may then be determined on the basis of the priority level (i.e., high-priority particles are made larger than low-priority particles). The priority level is merely an example, however, and other methods can also be used. It is necessary to prioritize such particles because the shortened texture is generated by deforming the reference texture. In other words, because the reference distribution information and the shortened distribution information references when generating the shortened intermediate texture are both determined on the basis of the same single reference texture, all the particles can be associated between the reference texture and the shortened texture, and thus correspond to the first class in the extended expression.

As with the reference texture, the extended intermediate texture, and the concatenated texture, it is necessary to control the arrangement positions and the arrangement sizes of the particles with respect to the ends, such that the particles do not become discontinuous at the boundary parts when the textures are arranged adjacent to each other. Accordingly, for the grid regions corresponding to the ends, the arrangement positions of those particles are fixed to maintain the distribution state of the particles at the ends in the reference texture 901, and the arrangement sizes of the other particles included in the grid regions in which the stated particles are arranged are forcibly set to 0. FIG. 9C illustrates the shortened intermediate texture at ½ the length, generated by determining the arrangement positions and the arrangement sizes of the particles in this manner.

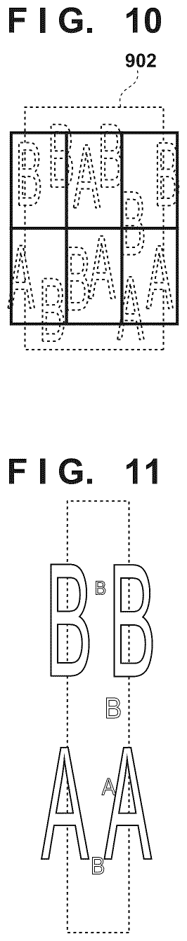

In the shortened intermediate texture at ½ the length shown in FIG. 9C, the length of the region in which the particles are arranged is sufficient in the longitudinal direction. It is therefore possible to set the arrangement size of the particles at the ends to the same size as in the reference texture 901. However, depending on the output length, the longitudinal direction length of the particles may exceed the output length. As such, for output lengths shorter than the longitudinal direction length of the particles, the particles may be compressed in the longitudinal direction as illustrated in FIG. 11 to ensure that the texture expression does not change due to particle overlap.

Additionally, although the present embodiment describes a method in which the arrangement size of the particles is adjusted to maintain the arrangement frequency of the particles in the generation of the shortened intermediate texture, the present invention is not limited thereto. For example, as with the extended intermediate texture, the arrangement frequency of the particles in the shortened intermediate texture may be maintained by adjusting the opacity of the particles. Alternatively, the arrangement frequency may be maintained by adjusting both the arrangement size and the opacity of the particles.

Arranging the particles in each pattern at the arrangement positions and arrangement sizes determined in this manner makes it possible to generate textures having a common texture expression for a plurality of types of output lengths up to the double length. Although details will be given later, the generated line segment drawing textures (the reference texture, the concatenated texture, the extended intermediate texture, and the shortened intermediate texture) can be used to express a homogeneous texture expression for line segments having a length of 0 to the double length. The line segment drawing textures can be arranged adjacent to each other, and thus a homogenous texture expression can be expressed using a plurality of line segment drawing textures even for line segments having a length longer than the double length.

In the present embodiment, a line segment drawing texture is generated for each length stage obtained by equal division into 32 stages up to the double length, and when drawing a line segment whose length changes, the textures are applied while sequentially switching the texture according to length of the line segment. Although details will be given later, when drawing a line segment having a length that is no greater than the double length and for which a line segment drawing texture has not been generated, for example, among line segment drawing textures shorter than the stated length, the longest line segment drawing texture is extended to the length of the line segment and used. Then, when the line segment is extended and reaches the next length stage, the texture is switched to that length stage.

For this reason, it is preferable for the line segment drawing texture to be configured so as not to cause the user to perceive the switching of the applied texture in the line segment that is drawn. Accordingly, it is assumed that between the line segment drawing texture at one length stage (a first length) and the line segment drawing texture at the next length stage (a second length), information on the arrangement of the particles is determined such that the similarity of the distribution states of the particles is ensured to a certain extent.

More specifically, a texture of the first length (called a “first texture” hereinafter) is extended as needed and applied to line segments having a length that is at least the first length and less than the second length. Accordingly, when line segments are extended sequentially from the first length and reach the second length, a switch is made from the first texture to a texture of the second length (called a “second texture” hereinafter).

According to the line segment drawing texture generation method described above, the arrangement size of each particle is adjusted according to the output length such that the arrangement frequency of the particles is constant regardless of the output length, and the arrangement positions are adjusted based on the distribution state in the reference texture or the concatenated texture according to the output length such that the relative positions in the regions of the texture are maintained. Accordingly, the degree to which the distribution states of the particles differ between the first texture and the second texture, i.e., whether the switch is easily perceived by the user when the first texture is switched to the second texture, depends on the difference in the lengths to which the respective textures correspond (the first length and the second length).

Additionally, when the first texture is extended to approximately the same length as the second length, the shapes of the particles in the first texture change. The ease with which the switch is perceived when switching from the first texture to the second texture therefore changes according to the extent to which extension processing is applied immediately before switching to the second texture. In other words, the extent to which the first texture is extended before switching to the second texture also depends on the magnitude of the difference in the lengths to which the respective textures correspond.

In other words, to generate a line segment drawing texture for which a user will not easily perceive a switch and that ensures a constant texture expression, it is preferable to employ a configuration in which the similarity between the first texture and the second texture is at least a threshold when the first texture and the second texture are set to the same length. In other words, if, when the first texture is extended to the second length, the texture expression (appearance) formed by the distributed particles is similar to that of the second texture, the user will not perceive the switching of the line segment drawing texture during the extension or shortening of the line segment, and will have the impression that the texture expression remains seamless.

The following will describe a generalized case in which each of N types of textures generated as line segment drawing textures (N=32 in the present embodiment) is generated as T[m] (where m is an integer satisfying 0≤m<N). In this case, the line segment drawing textures are N types among N+1 textures that change in stages from 0 to Se times the reference length (an integer value; in the present embodiment, Se=2), excluding 0 times. Numerical values from 0 to N−1 are assigned thereto, from the shortest to the longest, as m, and one texture can be identified by T[m] on the basis of that numerical value (number) m. At this time, when the length in the longitudinal direction of T[m] is S[m] times the reference length, the relationship between m and S[m] can be expressed as follows (when the length is determined by equal divisions up to Se times):

$$S [ m ] = Se \times \frac{m + 1}{N}$$

At this time, when the number corresponding to the first length is represented by m and the number corresponding to the second length is represented by m+1, T[m] has a length that is S[m] times the reference length, and T[m+1] has a length that is S[m+1] times the reference length. Accordingly, the difference in the longitudinal direction length between the texture T[m] of the first length and the texture T[m+1] of the second length is:

$${L}_{ref} \times S [ m + 1 ] - {L}_{ref} \times S [ m ] = {L}_{ref} \times \frac{Se}{N}$$

Here, L_{ref} is the reference length. In other words, as the number of line segment drawing texture length patterns, i.e., the number of divisions N having a length from 0 to Se times, increases, it becomes more difficult for the user to perceive the change when switching to the next-longest line segment drawing texture. This is because as the difference between S[m] and S[m+1] decreases, the length range over which T[m] is extended and applied (an intermediate length between S[m] and S[m+1]) narrows, and there are fewer chances to display a texture in which the shape of the particles has changed (extended in the longitudinal direction).

Preferably, configuring the texture to switch to a different line segment drawing texture each time the length of the line segment changes by one pixel makes it possible to present an extended or shortened expression that ensures a more homogeneous texture without displaying the extended texture. The number N of such length patterns can be derived as follows:

$$N = {L}_{ref} \times Se$$

By appropriately selecting the reference length and the number of types of line segment drawing textures to be generated in such a manner, when drawing a line segment using the textures, a line segment drawing texture group that ensures a homogeneous texture expression can be generated, in the same manner as when drawing a line segment by appropriately arranging particles. The number of the length patterns is therefore not limited to 32 as mentioned above, and can be set to any value, such as 64, 128, or the like, in accordance with the required quality of the line segment drawing texture (how apparent differences are during switching), the reference length, or the like.

### Drawing Line Segment Using Textures

An overview will now be given of processing for drawing a line segment accompanied by a texture expression using line segment drawing textures having a plurality of types of length patterns generated as described thus far. The drawing of the line segment is assumed to be provided as a function of the illustration editing application in the present embodiment. The processing for drawing a line segment using a texture can be classified into the following three types according to the length of the line segment.

(1) the Length of the Line Segment is Less than the Double Length

A line segment having a length less than the double length is drawn by applying one of the generated line segment drawing textures. At this time, the texture is selected as follows. If a texture having the length of the line segment is present, that texture is selected. However, if a texture having the length of the line segment is not present, the longest texture among textures shorter than the line segment is selected.

For example, if the reference length is L_{ref} and the length of the line segment is 1/2(0.5=2×8/32) times, a texture T[7] to which the number 7(=8−1) is assigned is used for the drawing. Likewise, T[7] is used until the length of the line segment exceeds the ½ times length of number 7 and reaches the length of number 8(2×(8+1)/32≈0.56 times). At this time, T[7] is extended according to the length of the line segment and applied. Then, when the length of the line segment reaches the length of the number 8, the texture to be applied is switched from T[7] to T[8].

### (2) the Line Segment is the Double Length

For a line segment having the double length, the 32nd texture T[31] among the generated line segment drawing textures has the same length. Here, T[31] is a concatenated texture, and therefore has the same appearance as two reference textures arranged adjacent to each other. Furthermore, the line segment drawing textures do not include a texture longer than T[31], and thus the texture cannot be switched to a longer texture if the line segment is extended further. As such, although the concatenated texture T[31] is to be selected on the basis of the length of the line segment, two reference textures T[15] are selected instead.

In other words, when the length of the line segment is the double length, the line segment can be drawn using the one texture T[31], but is instead drawn using the two reference textures T[15]. To rephrase, the concatenated texture T[31] is generated by concatenating the two reference textures T[15] to begin with, and the user therefore cannot recognize the substitution even if the texture T[30] is replaced by two of the textures T[15] at a length where the texture switches from T[30] to T[31].

(3) the Length of the Line Segment is More than the Double Length

On the other hand, for a line segment having a length exceeding the double length, a proper texture expression cannot be added to the line segment by applying one of the generated line segment drawing textures. When the line segment is the double length, the texture applied to the line segment is replaced, with one (T[31]) being replaced by two (T[15]×2). Accordingly, for a line segment having a length exceeding the double length, a texture expression is added by switching each of the replaced textures to a longer texture and applying the result.

For example, if the length of the line segment is three times the length of the reference length, the line segment accompanied by a texture expression is drawn by applying two of the texture T[23], which has a length of 1.5, adjacent to each other. In other words, in the process of sequentially extending the line segment, the two reference textures applied by replacing the textures at the point in time when the double length is reached are sequentially switched to a longer texture, according to the length of the line segment. Then, when the length of the line segment reaches four times the reference length, the two textures both switch to the texture T[31] (concatenated texture) that is the double length, and are therefore replaced by two of the reference texture T [15], as when drawing a line segment having the double length. Accordingly, when the line segment extends by more than four times the reference length, each texture that is sequentially replaced is switched to a texture of a different length.

In other words, the number of line segment drawing textures applied is doubled every time the length of the line segment becomes 2N times the reference length (i.e., the textures are replaced by 2N reference textures). Accordingly, the number of textures used to draw the line segment can be derived from N, which is the number of times that an integer value, obtained by dividing the length of the line segment by the reference length and casting that value to an integer type, can be shifted to the right when expressed in binary until the value becomes 0 (2N).

By doing so, according to the illustration editing application according to the present embodiment, a line segment which maintains a homogeneous texture expression up to an infinite length can, in principle, be drawn using a limited number of types of line segment drawing textures.

Note that in the present embodiment, to facilitate understanding of the invention, when drawing a line segment by applying a plurality of line segment drawing textures, those textures are assumed to be textures of the same length. In other words, it is assumed that a single type of line segment drawing texture is applied in multiple in a given instance of drawing a line segment. This makes it possible to make the distribution state of the particles uniform throughout the line segment. However, the present invention is not limited thereto, and for example, line segment drawing textures of different lengths may be combined and applied according to the length of the line segment.

### Generation Processing

Generation processing for generating a line segment drawing texture in the illustration editing application according to the present embodiment will be described in detail next with reference to the flowchart in FIG. 12. The processing corresponding to the flowchart can be realized by, for example, the control unit 101 reading out a corresponding processing program stored in the storage device 102, loading the program into the memory 103, and executing the program. Note that this generation processing will be described as being started when, for example, the condition information pertaining to a generation rule for a reference texture is input.

In step S1201, the control unit 101 generates the reference texture on the basis of the input condition information, and obtains the reference distribution information of the generated reference texture. Here, the condition information is assumed to include information on the pattern in which the particles are arranged in the reference texture, information on the arrangement frequency of the particles per unit of length, and information on the reference length. On the basis of the condition information, the control unit 101 obtains the reference distribution information by determining the arrangement positions of the particles in each pattern so as to satisfy the arrangement frequency of the particles.

In step S1202, the control unit 101 determines the output length for each line segment drawing texture generated in addition to the reference texture. The output length for each texture is determined by taking a length obtained by multiplying the reference length by a predetermined integer value as a maximum length, and dividing a length range from 0 to the maximum length equally into a predetermined number of divisions. In the example described above, the predetermined integer value is 2, and the number of divisions is 32. Here, the predetermined integer value and the number of divisions may be determined in advance, or may be determined on the basis of an input made by the user, for example.

In step S1203, the control unit 101 determines the arrangement positions of the particles for each of the generated line segment drawing textures on the basis of the reference distribution information. The control unit 101 also determines the arrangement size of the particles as necessary. More specifically, the control unit 101 determines the arrangement positions of the particles differently for an output length determined in step S1202 to be longer than the reference length (an output length for an extended expression) and an output length determined in step S1202 to be shorter than the reference length (an output length for a shortened expression).

With respect to the output length for the extended expression, the control unit 101 first generates a concatenated texture by concatenating the reference texture, and obtains the concatenated distribution information of the generated concatenated texture. The control unit 101 then associates the particles distributed in the reference texture with the particles distributed in the concatenated texture on the basis of the reference distribution information and the concatenated distribution information, and classifies the particles. The control unit 101 then sets the arrangement positions of the particles for each output length in accordance with the classes thereof. For particles of the second class, the control unit 101 also determines the arrangement size on the basis of the reference distribution information, the concatenated distribution information, the information on the classes of the particles, and the information of the arrangement frequency of the particles.

With respect to the output length for the shortened expression, the control unit 101 obtains the shortened distribution information corresponding to the output length by converting the reference distribution information in accordance with each output length. The control unit 101 then determines the arrangement positions of the particles on the basis of the shortened distribution information. The control unit 101 also determines the arrangement size on the basis of the shortened distribution information, the priority levels of the particles, and the information on the arrangement frequency of the particles.

In step S1204, under the control of the control unit 101, the drawing unit 104 generates a line segment drawing texture (an extended intermediate texture and a shortened intermediate texture) for each output length on the basis of the information on the arrangement positions and arrangement sizes of the particles determined in step S1203. In other words, the drawing unit 104 generates a line segment drawing texture for each output length by arranging particles of a corresponding pattern at the determined arrangement positions. The generated texture is stored in the storage device 102 in association with the output length.

### Drawing Processing

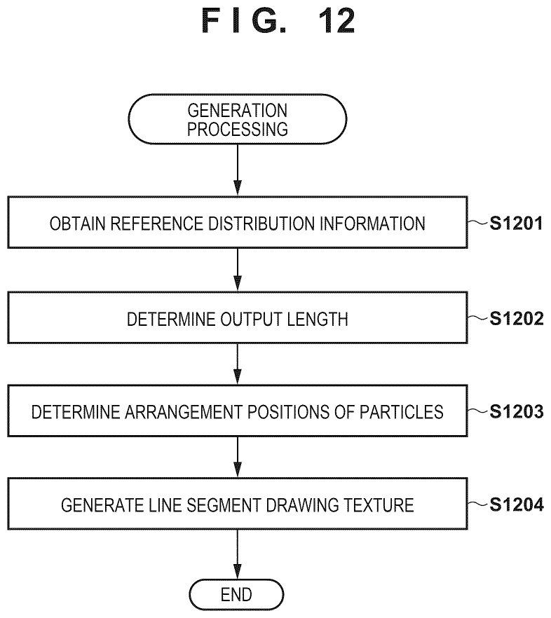

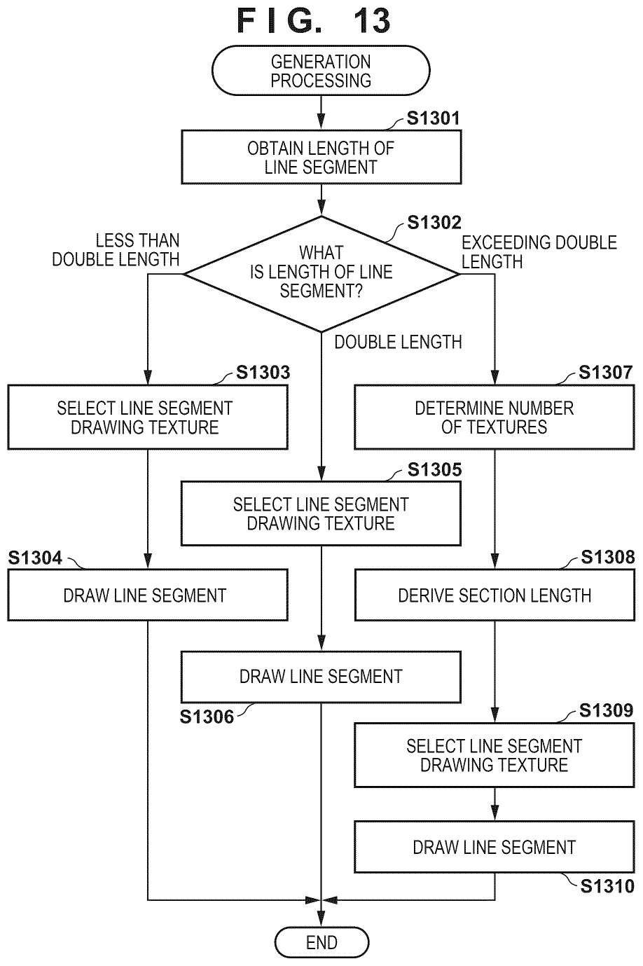

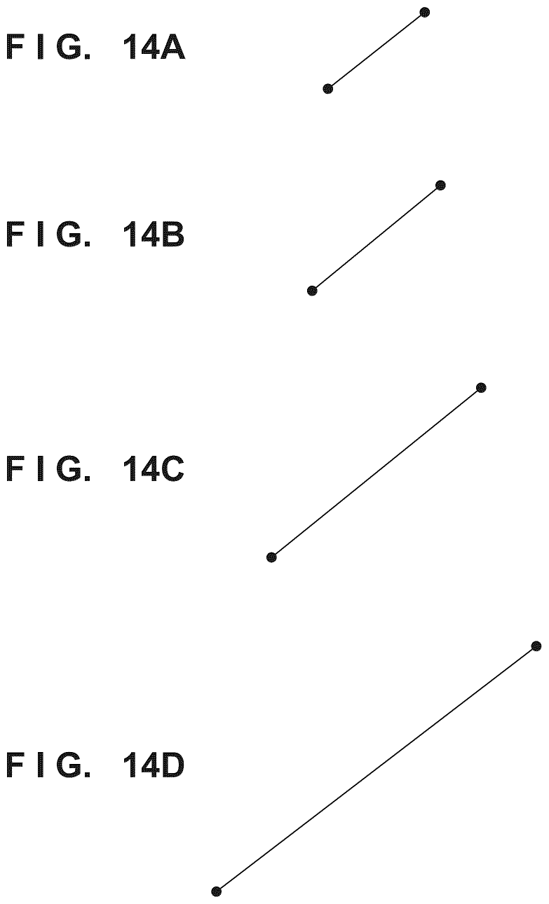

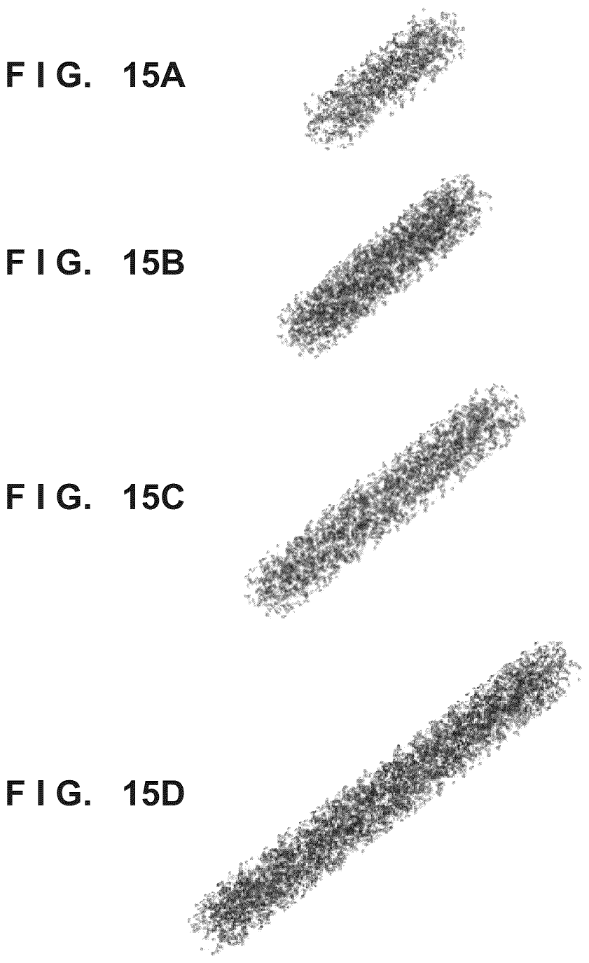

Next, drawing processing for drawing a line segment accompanied by a texture expression in the illustration editing application according to the present embodiment will be described in detail next with reference to the flowchart in FIG. 13. The processing corresponding to the flowchart can be realized by, for example, the control unit 101 reading out a corresponding processing program stored in the storage device 102, loading the program into the memory 103, and executing the program. Note that this drawing processing will be described as being started when, for example, an input pertaining to a change in the length of the corresponding line segment is received, and executed repeatedly for a period in which the input continues. It is also assumed that a line segment drawing texture of each length for the texture expression to be drawn is loaded into a GPU memory of the memory 103 or the drawing unit 104 prior to the drawing processing being executed. The following descriptions assume that the line segment drawing texture is generated for a length range up to twice the reference length.

In step S1301, the control unit 101 obtains the length of the line segment to be drawn. The length of the line segment is derived on the basis of vector information of the baseline input for defining the line segment.

In step S1302, the control unit 101 determines whether the length of the line segment obtained in step S1301 is a length less than double the length of the reference texture, the double length, or a length exceeding the double length. The sequence moves to step S1303 when the control unit 101 determines that the length of the line segment is less than double the length; to step S1305, when the control unit 101 determines that the line segment is the double length; and to step S1307, when the control unit 101 determines that the line segment exceeds the double length.

In step S1303, the control unit 101 selects a single line segment drawing texture corresponding to the length of the line segment. More specifically, of the line segment drawing textures for the texture expression to be drawn, the control unit 101 selects one texture having the longest length that is less than or equal to the length of the line segment.

In step S1304, under the control of the control unit 101, the drawing unit 104 draws the line segment by applying the line segment drawing texture selected in step S1303 to the baseline. At this time, if the length of the line segment drawing texture and the length of the line segment are different, the drawing unit 104 assumes that the line segment drawing texture is to be extended to the length of the line segment and applied. The drawn line segment is included in a screen of the illustration editing application, and is displayed on the display unit 110 by the display control unit 105.

On the other hand, if the length of the line segment is determined in step S1302 to be the double length, in step S1305, the control unit 101 selects a line segment drawing texture corresponding to the length of the line segment. At this time, the line segment drawing texture corresponding to the length of the line segment is a concatenated texture, but when the concatenated texture is selected, the control unit 101 replaces the concatenated texture with two reference length textures.

In step S1306, under the control of the control unit 101, the drawing unit 104 draws the line segment by applying the line segment drawing textures selected in step S1305 (the two reference textures) to the baseline. The drawn line segment is similarly included in a screen of the illustration editing application, and is displayed on the display unit 110 by the display control unit 105.

In step S1307, the control unit 101 determines the number of line segment drawing textures to be used (called a “number of textures” hereinafter) on the basis of the length of the line segment.

In step S1308, the control unit 101 derives the length of a section to which a single line segment drawing texture is to be applied (a section length) by dividing the length of the line segment by the number of textures.

In step S1309, the control unit 101 selects a single line segment drawing texture corresponding to the section length. More specifically, of the line segment drawing textures for the texture expression to be drawn, the control unit 101 selects one texture having the longest length that is less than or equal to the section length.

In step S1310, under the control of the control unit 101, the drawing unit 104 draws the line segment by arranging a number of the line segment drawing textures selected in step S1308 equal to the number of textures and applying those textures to the baseline. At this time, if the length of the line segment drawing texture and the section length are different, the drawing unit 104 assumes that each line segment drawing texture is to be extended to the section length and applied. The drawn line segment is similarly included in a screen of the illustration editing application, and is displayed on the display unit 110 by the display control unit 105.

Although the present embodiment describes the illustration editing application as drawing a line segment accompanied by a texture expression using the line segment drawing texture, the present invention is not limited thereto. The drawing of the line segment accompanied by a texture expression may be performed by any application that can utilize the line segment drawing textures generated by the generation process. In other words, the present invention for line segment drawing can be carried out in any information processing apparatus that obtains and stores a line segment drawing texture generated through the generation processing, and does not necessarily need to be carried out in an application that generates a line segment drawing texture or in the information processing apparatus that generates the line segment drawing texture.

As described above, according to the drawing program of the present embodiment, a line segment accompanied by a desired texture expression can be drawn while avoiding increasing the computation amount. For example, a desired curve constituted by at least two control points can be configured to express a uniform texture expression across the entirety thereof by drawing a line segment drawing texture based on a length of a part between two control points arranged consecutively on the curve (a segment), on the basis of drawing processing. At this time, the distribution state of the particles at the ends is configured to be common among the line segment drawing textures, and thus a drawing expression in which the particles are naturally concatenated at concatenated parts of consecutive segment can be achieved. Furthermore, even if the length of each segment is changed, the texture is sequentially replaced by a corresponding number of reference textures until the length reaches an integer multiple of the reference length, and as a result, a line segment providing a uniform texture expression that can be smoothly extended and shortened from a length of 0 to infinity can be expressed at a small computation amount.

Although the present embodiment describes the concatenated texture as being generated by concatenating two reference textures, the present invention is not limited thereto. From the viewpoint of minimizing the number of textures generated, it is preferable that the length of the concatenated texture serving as the reference for generating the extended intermediate texture be twice the reference length, as described above. However, it goes without saying that the length of the concatenated texture may be any length that is a predetermined integer multiple of the reference length, and that an integer value of 3 or more may be used as the predetermined integer.

For example, if the predetermined integer is 3, a concatenated texture is generated by concatenating three reference textures, and line segment drawing textures are generated for a length range from 0 to 3 times the length. Then, in the drawing processing using those line segment drawing textures, whenever the length of the line segment becomes 3N times the length of the reference length, three reference textures may be applied instead for the section to which the concatenated texture is to be applied.

### First Variation

According to the foregoing embodiment, if no line segment drawing texture having the same length as the line segment to be drawn is present, i.e., if the length of the line segment is an intermediate length between the first length and the second length in the length pattern, a texture having a length that is shorter than the length of the line segment is extended and applied. However, the present invention is not limited thereto, and an intermediate length texture for the intermediate length line segment may be generated and applied by compositing line segment drawing textures having a plurality of lengths by averaging or weighted addition.

### Second Variation

The foregoing embodiment described a configuration where, when generating the extended intermediate texture, the particles of the first class are associated when particles of the same pattern are distributed in the grid region where the grid coordinates are common. However, the present invention is not limited thereto. The particles of the first class may be associated when the particles of the same pattern are distributed within a range that is a predetermined distance from a point in the concatenated texture where the relative coordinates are common with a given particle in the reference texture.

### Other Embodiments

The invention is not limited to the foregoing embodiments, and various variations/changes are possible within the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A computer-readable recording medium having recorded thereon a program executed by a computer that outputs textures having a plurality of types of output length, wherein the textures form a texture expression of a line segment having a predetermined width by being disposed in an area corresponding to the line segment when drawing the line segment, and are selectively disposed according to a length of the line segment, the program causing the computer to:
obtain, for a reference texture having a reference length and the predetermined width, distribution information regarding a distribution state of texture-forming elements that form a texture expression in the reference texture;
determine the plurality of types of output length that indicates a length of a texture to be generated and that is different from the reference length;
determine arrangement positions of the texture-forming elements in the texture having each types of output length based on the obtained distribution information; and
generate and output the textures having the plurality of types of output length and the predetermined width by arranging the texture-forming elements at the determined arrangement positions.

2. The recording medium according to claim 1,
wherein in a case where the output length is longer than the reference length, in the determining of the arrangement positions, the arrangement positions of the texture-forming elements are determined based on a distribution state of the texture-forming elements in the reference texture and a distribution state of the texture-forming elements in a concatenated texture obtained by concatenating a predetermined integer number of the reference textures without overlapping.

3. The recording medium according to claim 2,
wherein the program further causes the computer to:
associate, between the reference texture and the concatenated texture, the texture-forming elements distributed in the reference texture and the concatenated texture; and
classify the texture-forming elements distributed in the reference texture and the concatenated texture in accordance with a result of the associating, and
in a case where the output length is longer than the reference length, in the determining of the arrangement positions, the arrangement positions of the texture-forming elements are determined through different determination methods depending on a result of the classifying.

4. The recording medium according to claim 3,
wherein there are a plurality of types of texture-forming elements distributed in the reference texture,
in the associating, texture-forming elements that are of the same type and have the same relative positions in regions, of the reference texture and the concatenated texture, in which the texture-forming elements are distributed, are associated with each other, and
in the classifying, the associated texture-forming elements are classified into a first class, and the texture-forming elements that are not associated are classified into a second class different from the first class.

5. The recording medium according to claim 4,
wherein in a case where the output length is longer than the reference length, in the determining of the arrangement positions, the arrangement positions of the texture-forming elements classified into the first class are determined based on relative positions of the texture-forming elements in the reference texture, relative positions of the texture-forming elements in the concatenated texture, and the output length.

6. The recording medium according to claim 4,
wherein in a case where the output length is longer than the reference length, in the determining of the arrangement positions, at least one of an arrangement size and an opacity is further determined in addition to the arrangement positions for the texture-forming elements classified into the second class.

7. The recording medium according to claim 6,
wherein the second class includes:
a first texture-forming element that is the texture-forming element distributed in the reference texture and for which a texture-forming element of the same type is not present in a region of the concatenated texture at a common relative position; and
a second texture-forming element that is the texture-forming element distributed in the concatenated texture and for which a texture-forming element of the same type is not present in a region of the reference texture at a common relative position, and
in a case where the output length is longer than the reference length, in the determining of the arrangement positions,
an arrangement position of the first texture-forming element is determined based on a relative position of the first texture-forming element in the reference texture and the output length, and
an arrangement position of the second texture-forming element is determined based on a relative position of the second texture-forming element in the concatenated texture and the output length.

8. The recording medium according to claim 7,
wherein in a case where the output length is longer than the reference length, in the determining of the arrangement positions,
an arrangement size of the first texture-forming element is determined to be smaller as the output length increases, and
an arrangement size of the second texture-forming element is determined to be smaller as the output length decreases.

9. The recording medium according to claim 7,
wherein in a case where the output length is longer than the reference length, in the determining of the arrangement positions,
an opacity of the first texture-forming element is determined to be lower as the output length increases, and
an opacity of the second texture-forming element is determined to be lower as the output length decreases.

10. The recording medium according to claim 2,
wherein the plurality of types of output length determined in the determining of the plurality of types of output length does not exceed a length of the concatenated texture.

11. The recording medium according to claim 2,
wherein the predetermined integer is 2.

12. The recording medium according to claim 1,
wherein in a case where the output length is shorter than the reference length, in the determining of the arrangement positions, the arrangement positions of the texture-forming elements are determined based on a distribution state of the texture-forming elements in the reference texture and a distribution state of the texture-forming elements in a shortened texture obtained by shortening the reference texture to the output length.

13. The recording medium according to claim 12,
wherein in a case where the output length is shorter than the reference length, in the determining of the arrangement positions, at least one of an arrangement size and an opacity is further determined, in addition to an arrangement position in the texture having the output length, for each of the texture-forming elements distributed in the reference texture.

14. The recording medium according to claim 1,
wherein the distribution state of the texture-forming elements at an end of the texture having the output length is common with the reference texture.

15. The recording medium according to claim 1,
wherein a difference in an arrangement frequency of the texture-forming elements per unit of length between the texture having the output length and the reference texture is less than a predetermined threshold for visual identification of appearance.

16. The recording medium according to claim 1,
wherein the texture having the output length generated in the generating is a texture in which texture-forming elements that are distributed form a texture expression common with the reference texture.

17. A drawing apparatus that outputs textures having a plurality of types of output length, wherein the textures form a texture expression of a line segment having a predetermined width by being disposed in an area corresponding to the line segment when drawing the line segment, and are selectively disposed according to a length of the line segment, the drawing apparatus comprising:
at least one processor; and
at least one memory storing a computer program, the computer program causing the at least one processor to function as the following units:
an obtaining unit configured to obtain, for a reference texture having a reference length and the predetermined width, distribution information regarding a distribution state of texture-forming elements that form a texture expression in the reference texture;
a first determining unit configured to determine the plurality of types of output length that indicates a length of a texture to be generated and that is different from the reference length;
a second determining unit configured to determine arrangement positions of the texture-forming elements in the texture having each types of output length based on the distribution information obtained by the obtaining unit; and
a generating unit configured to generate and output the textures having the plurality of types of output length and the predetermined width by arranging the texture-forming elements at the arrangement positions determined by the second determining unit.

18. A drawing method for outputting textures having a plurality of types of output length, wherein the textures, wherein the textures form a texture expression of a line segment having a predetermined width by being disposed in an area corresponding to the line segment when drawing the line segment, and are selectively disposed according to a length of the line segment, the drawing method comprising:
obtaining, for a reference texture having a reference length and the predetermined width, distribution information regarding a distribution state of texture-forming elements that form a texture expression in the reference texture;
determining the plurality of types of output length that indicates a length of a texture to be generated and that is different from the reference length;
determining arrangement positions of the texture-forming elements in the texture having each types of output length based on the obtained distribution information; and
generating and outputting the textures having the plurality of types of output length and the predetermined width by arranging the texture-forming elements at the determined arrangement positions.
